(19) United States
(12) Patent Application Publication
(10) Pub. No.: US 2006/0287813 A1
(43) Pub. Date: Dec. 21, 2006

(54) Proximate location detection system and method

(76) Inventor: Aaron Quigley, Dublin (IE)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/441,467

(22) Filed: May 23, 2006

Related U.S. Application Data
(63) Continuation of application No. PCT/AU04/01515, filed on Nov. 1, 2004.

(30) Foreign Application Priority Data
Oct. 31, 2003 (AU) AU 2003906015

(51) Int. Cl. G01C 21/00

(52) U.S. Cl. 701/201

(57) ABSTRACT

A proximate location detection system and method is provided. A user carries a mobile location indicating device which initially determines the general geographic area in which the device is located. The device is able to download map data in relation to the general geographic area, the map data comprises details of beacons and their locations within the general geographic area. The device is then able to passively detect and identify beacons within its physical proximity. The identity of the detected beacons is then compared with the downloaded data to determine their location which is then displayed to the user as their proximate location within the general geographic area. Hence, the user can approximately track their own movements within a large area without third parties being able to determine the user's location within the large area.

### CROSS-REFERENCE TO RELATED APPLICATION

This application is a continuation application of International Application No. PCT/AU2004/001515, filed 1 Nov. 2004 and published as WO 2005/043940 A1 on 12 May 2005, which claims priority to Australian Patent Application Serial No. 2003906015, filed 31 Oct. 2003, and claims the priority thereof, the subject matter of which is hereby incorporated by reference in its entirety.

### FIELD OF THE INVENTION

The present invention relates to proximate location detection systems and methods which allow determination of the proximate location of a user of the system within a geographical area and indicating such to the user.

### BACKGROUND OF THE INVENTION

A number of position locating systems have previously been described.

For example in U.S. Pat. No. 6,529,164 (Carter) an object location monitoring system tracks the locations of portable transceivers that attach to movable objects, such as patients within a hospital. Chirpers or ‘beacons’ that intermittently transmit unique ID codes are mounted to walls or other structures throughout areas of a building.

Each transceiver records the beacon IDs, and determines the received signal strengths, of the beacon transmissions it detects. The received signal strength establishes a maximum plausible distance between the beacon and the transceiver. The transceivers forward some or all of this information to a server or other processing node. The processing node uses this information, together with information about expected received signal strengths in specific areas, to predict the current location of each transceiver. The invention thus described by Carter involves the identification of the location of the portable transceiver to an entity external to the transceiver.

U.S. Pat. No. 6,498,565 (Boulay et al.) is a two way tracking system and method using an existing wireless network. With such a system, a security service provider may track the location of, for example, a cellular telephone which is installed in a stolen vehicle.

U.S. Pat. No. 6,445,344 (Wise et al.) is a local area positioning system which comprises a plurality of platforms or nodes consisting of airborne and/or ground based vehicles that are coupled in a platform-to-platform local area network. Tracking apparatus in each platform generates updated estimates of position and velocity vectors associated with each node. Thus the position of a target is generated within nodes that are separate from that target.

U.S. Pat. No. 6,327,535 (Evans et al.) describes context-aware computing systems and methods. Context providers, external to, for example, a laptop computer that is being used by a user, provide context information (relating to the position of the laptop computer) so that location dependent goods or services can be rendered. Here again, the system enables the context provider to become aware of the precise location of the user to whom context information is provided.

Privacy laws in most countries require that personal data of individuals be treated confidential by service providers who have access to or have been provided by subscribers to the service with such information. It is evident that location detection systems allow a service provider to compile data about movement patterns of individual user participants, which is, in effect, personal data that is subject to privacy laws. Consequently, security measures have to be implemented to prevent unauthorized access to the information, which makes implementation of such systems in a commercial environment more expensive and sensitive to run.

In light of privacy concerns by users of systems that allow providers to gather personal information of the nature described above, it would be advantageous if a location (or proximity) detection system and method could be implemented in which the end user, as distinct from other components of the system and/or administrators thereof, can download information that allow the end user to determine his/her location.

It would be equally advantageous if such a system and method could be refined to enable the end user to select the level of resolution of user location which other components of the system and/or administrators may be allowed by the user to access. Within the last aim, it would be particularly advantageous were the system user configurable such that only the user, as distinct from other components of the system and/or administrators thereof, is able to access information about the user's fine grained location within indoor or outdoor environments.

### SUMMARY OF THE INVENTION

According to a first aspect of the present invention there is provided a method of determining and indicating a proximate location of a user within a general geographical area, said method comprising the steps of:
a) determining the general geographical area in which the user is located;
b) requesting and downloading data providing details of said general geographical area onto a mobile location indicating device, said details comprising map data of said general geographical area, location data of beacons within said general geographical area and unique identifier(s) associated with each beacon;
c) the mobile location indicating device passively detecting one or more beacons within the proximity of the mobile location indicating device, and determining the unique identifier(s) of said one or more detected beacons;
d) the mobile location indicating device comparing the determined unique identifier(s) with the downloaded data, thereby determining respective location data of said one or more detected beacons; and
e) the mobile location indicating device communicating to the user said determined respective location data as the proximate location of the user within the general geographic area.

According to a second aspect of the present invention there is provided a system for determining and indicating a proximate location of a user within a general geographical area, said system comprising:
a plurality of beacons located within the general geographical area, said beacons each having a unique identifier; and
a mobile location indicating device, said device comprising:
   means for determining the general geographical area in which the mobile location indicating device is located;
   means for requesting and downloading data providing details of said general geographical area, said details comprising map data of said general geographical area, location data of said plurality of beacons and the unique identifiers associated with each of said plurality of beacons;
   means for passively detecting one or more beacons within the proximity of the mobile location indicating device;
   means for determining the unique identifier(s) of said one or more detected beacons;
   means for comparing the determined unique identifier(s) with the downloaded data and determining respective location data of said one or more detected beacons; and
   means for communicating to the user said determined respective location data as the proximate location of the user within the general geographic area.

In preferred embodiments the downloaded data comprises further information relevant to the determined proximate location that can be communicated to the user. Ideally, this further information is tailored to the user's preferences.

Alternatively, or additionally, the method may comprise a step allowing the user to request and download further data specific to the determined proximate location.

According to a third aspect of the present invention there is provided a method of providing consumer information to a consumer within a general geographical area, wherein said consumer information pertains to goods and/or service providers within the proximate location of the consumer within the general geographical area, said method comprising the steps of:
determining the general geographical area in which the consumer is located;
requesting and downloading data providing details of said general geographic area onto a mobile device, said details comprising map data of said general geographical area, location of beacons within said general geographical area, unique identifier(s) associated with each beacon and consumer information relevant to the proximity of each beacon location;
the mobile device passively detecting one or more beacons within the proximity of the mobile device, and determining the unique identifier(s) of said one or more detected beacons;
the mobile device comparing the determined unique identifier(s) with the downloaded data, thereby determining respective location of said one or more detected beacons; and
the mobile device communicating consumer information relevant to the proximity of the determined respective location of said one or more detected beacons to the consumer.

According to a fourth aspect of the present invention there is provided a system for providing consumer information to a consumer within a general geographical area, wherein said consumer information pertains to goods and/or service providers within the proximate location of the consumer within the general geographical area, said system comprising:
a plurality of beacons located within the general geographical area, said beacons each having a unique identifier; and
a mobile device, said device comprising:
   means for determining the general geographical area in which the mobile device is located;
   means for requesting and downloading data providing details of said general geographical area, said details comprising map data of said general geographical area, location of said plurality of beacons, the unique identifiers associated with each of said plurality of beacons and consumer information relevant to the proximity of each beacon location;
   means for passively detecting one or more beacons within the proximity of the device;
   means for determining the unique identifier(s) of said one or more detected beacons;
   means for comparing the determined unique identifier(s) with the downloaded data and determining respective location of said one or more detected beacons; and
   means for communicating consumer information relevant to the proximity of the determined respective location of said one or more detected beacons to the consumer.

In its first aspect, the present invention offers the advantage of providing only the user of the system, a person with such mobile location indicating device, with their proximate location which cannot be tracked or recorded by a third party unless offered by the person. At best, only the general geographical area in which the person is located could be determined by a third party, eg where the step of determining the geographical area comprises the use of a GSM network to download high-level location and geographical area data and map information. However, the person's movements in said geographic area cannot be tracked until the person requests further information specific to a particular location.

In its third aspect, the present invention provides a marketing tool for goods/services providers located in a general geographic area, allowing these to provide information, eg advertisements, to a user present in the general geographic area, once such user detects with the mobile location indicating device his/her proximate location with the help of the passive beacons.

From a viewpoint of a user, the invention provides, in its different aspects, a secure way of determining the proximate location of a user within a given broader/larger area as well as the option of receiving information about services/goods (or other type of information) of providers located in that area without divulging/giving away the user's fine grained position to any third party.

It will be appreciated that the invention's system and methods are devised to provide flexible indoor and outdoor location management schemes. The system is set-up to allow only the end user to be aware of their location while indoors, rather than provide a system which actively tracks the user. With such system, the end-user may provide or publish, on varying levels of granularity, their location details thus enabling information or group services to be actively downloaded by or passively pushed into an appropriate application tool of the mobile location indicating device.

Much of the existing research in the area of location awareness systems has focused on improving the accuracy of either the network positioning or indoor location tracking, rather than addressing the need for a scalable user-centric end-to-end solution. Further, many indoor tracking systems rely on special purpose receivers (badges) and transmitters in conjunction with a costly site “radio survey”. The accuracy of the location computation is then typically a function of the resolution of the radio survey.

In contrast, with the invention, location information is deduced by handset/PDA-resident (mobile terminal) applications which combine two sources of information:
Evidence from passive sniffing (detecting) of an existing (or dedicated) wireless infrastructure (Bluetooth, Wi-Fi, ultrawideband etc);
Details about the local wireless infrastructure which are provided based on system knowledge of the user's approximate location from the GSM network positioning system.

Thus a scalable delivery and data encoding mechanism for both the location mapping and location-tied data is provided. The invention's system integrates the approximate network location technologies currently available with low-cost, localised location-awareness. Typically, a handset-resident application will query the GSM network for its approximate location, which will then trigger the delivery of high-level mapping, local information and existing local wireless network information, which may be referred to as MIW (Mapping, Information, Wireless) data.

The local wireless network information delivered will allow the application to perform a number of tasks: the ability to position the end-user on a venue specific map, the ability to deliver data when in particular regions of the venue, and the ability to ask the GSM network for more localised MIW data. This refinement approach ensures the user's privacy as the GSM network is not being tasked with keeping track of individuals on a micro level. Here the handset-resident application keeps track of the user's location and only queries the GSM network for macro information. The invention's approach to location-awareness addresses both scalability and privacy concerns.

The information will consist of enough data for the handset-resident application to approximately locate itself within an indoor or outdoor setting. Along with this, an amount of SVG data is transmitted which allows the mapping application to render a high-level view of the area. Once the handset-resident application “sniffs” a location beacon, eg a wireless device of which it knows the location, it places the user on the map within the beacon transmission radius.

A more detailed description of embodiments of the invention is provided below with reference to the accompanying drawings.

### BRIEF DESCRIPTION OF THE DRAWINGS

FIG. 1 is a general concept flowchart of the principle behind the invention in its application to a specific system; and

FIG. 2 illustrates part of the hardware architecture of the system of FIG. 1.

### DESCRIPTION OF PREFERRED EMBODIMENTS

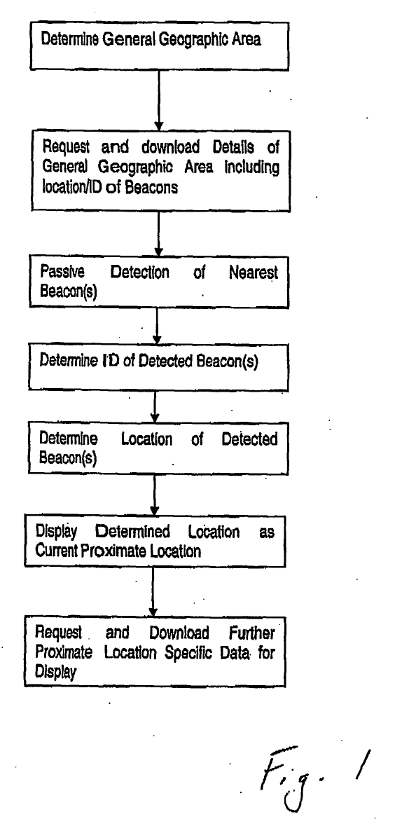

The aspect of the present invention that allows a user to determine his/her location (to an acceptable degree of resolution) within a general geographical area will be described by way of example in a specific implementation with reference to the flowchart of FIG. 1.

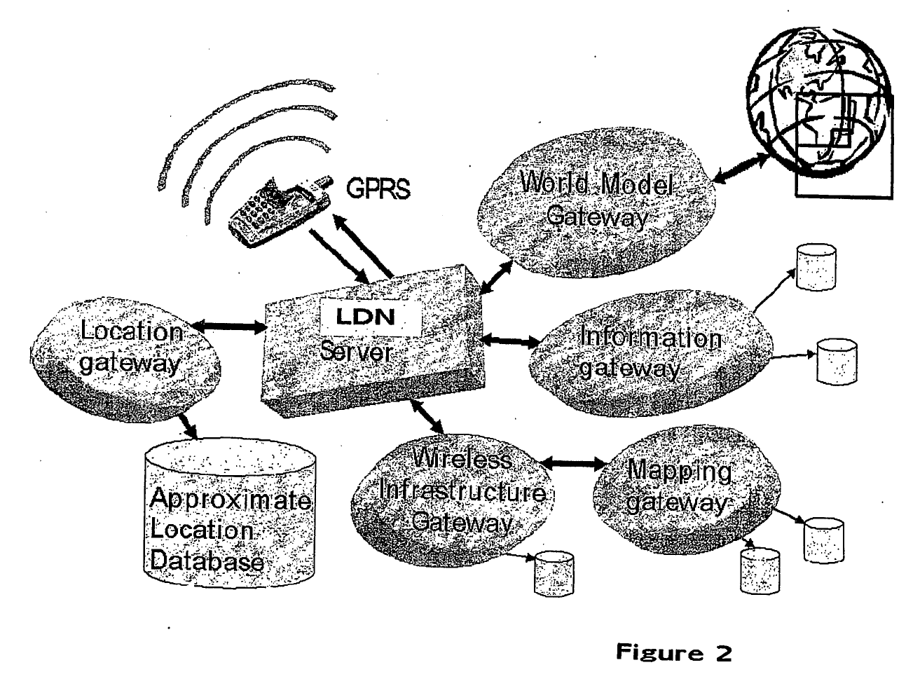

From a system point of view, the hardware of which is described below with reference to FIG. 2, the user initially needs to determine the general geographic area in which he/she is presently located. The user's mobile location indicating device is, in a preferred form of the invention, incorporated in a cellular mobile handset. Therefore, the general geographic area may be readily determined in a known manner by identifying the nearest base station of the mobile telephony network. It will be appreciated that a cellular base station is intended to cover a particular geographic area, i.e., its cell area, typically the cell area is an area of approximately 500 square meters. Thus this cell area will be taken to be the general geographic area. Of course, the cell area size will depend on the capabilities of the mobile telephony network.

The user can then request and download data of the cell area via the cellular network from a dedicated service provider. The downloaded data will, as a minimum, comprise a coarse map of the cell area, the location of locality or position beacons within the cell area and associated unique identifiers for the beacons. However, it is preferred that the downloaded data will comprise additional fine maps of areas within the proximity of each beacon and other useful data, for example: locations of places of interest, amenities, details of service providers etc. Ideally the type of useful data downloaded will be specific to the interests of the user, in which case the user may have a predetermined profile or preferences stored by the system provider to discriminate what data is to be downloaded.

A system architecture by way of which the above steps may be carried out is illustrated in FIG. 2. The architecture consists of a number of server-side components arranged to communicate a location determining node (LDN) server. A handset-resident application transmits to only the LDN server across a (standard) GPRS connection. Once the handset-resident location module makes its initial inquiry, the LDN server contacts a location gateway, typically a GSM mobile positioning centre (MPC), to determine the handset's approximate location (using time of arrival (TOA), cell ID or cell sector). The data returned from the location gateway is in the form of an approximate location element consisting of a series of line segments which define an enclosed region in space. This is due to the various positioning systems and their resolution used within the MPC. This approximate location element is channelled through a world model gateway which converts the element into an LDN specific format used to efficiently query an information gateway, the wireless infrastructure gateway, and for a map-based application, a mapping gateway. Rather than caching all mapping, information and wireless details, the approximate location allows LDN to extract a smaller portion of the world model, i.e., the cell area. This portion of the world model is delivered to the handset-resident application and is still large enough to ensure the system cannot micro-locate the end user within the cell area.

The initial position provided by the telecommunications network is thus merely used to determine which section of the world model should be downloaded to the user's device, which then allows users to self position themselves within that section. Rather than the mobile device employed by the user keeping an almanac of every possible position beacon in the world, subsections of the almanac are downloaded to a user's device when required. Part of the almanac comprises details on which particular beacon is at what location in the world.

The above approach thus addresses a major privacy issue by keeping the accurate location information under the user's local control. The more privacy someone wants, the larger the section of the world model that is able to be delivered to the user, to ensure the delivery system cannot deduce where the person is.

With the above steps completed, i.e., the course location of the user within a geographic area is determined, the mobile handset is then able to independently determine its proximate location within the cell area. The handset is enabled to passively receive transmissions of the location beacon(s) that are physically nearest to it, i.e., the beacon(s) whose transmission range permit reception thereof at the handset. In the case of an implementation using Bluetooth beacons, this transmission range is typically several meters. Each such beacon will comprise its respective unique identifier in its transmission. Thereby, a handset-resident application is able to passively detect and identify the nearest beacon(s). It is not necessary that these Bluetooth beacons be constantly or intermittently connected to a computing or communications network. The Bluetooth devices simply function as beacons to be ‘found’ in the environment rather than used for communication within a network. These beacons may have small form factors enabling them to, for example, plug into power sockets, light sockets, and cigarette lighter sockets in cars or other movable vehicles.

Application software in the handset then compares the identity of the detected beacon(s) with the downloaded data to determine the location(s) of the detected beacon(s). This location(s) can then be displayed to the user, thereby indicating the proximate location of the user to such location(s). The display may be the coarse map of the cell area with the proximate location indicated. Preferably, the application software will provide the option to the user of selecting a fine map of the proximate location.

Optionally, the user can then request and download further data relevant to the determined proximate location. Such data may comprise information or advertisements about shops or amenities within the proximate location, historical information about and directions to places of interest, shop and service provider locations, etc. The trade-off for requesting further data download is that such data will be more locality specific and thus user's proximate location may be more readily determined, if the further information is requested through and provided over the mobile telephony network. In an alternative embodiment, a local area network, that is independent from the telephony network, may be employed to provide the further data download. In yet a further embodiment, the further data can be provided directly from a service provider located within proximity of an individual beacon, i.e., in the case where a beacon identifies the location of a specific shop (service provider) that sells goods or services of which the user wishes to be notified.

One application scenario of the above described implementation of the invention is centred on people moving from outdoor environments into confined indoor or localised situations. These indoor situations may require the provision of both fine grained maps in conjunction with location dependent data.

Such an application scenario comprises a large multi-storey shopping centre located in a metropolitan area, or a large sporting complex such as an Olympic Park, for example.

In the shopping centre scenario, a user invokes a ‘proximity location detection’ application on a Bluetooth enabled smart phone, as they approach a large metropolitan shopping centre. This invocation causes an empty map to appear on the display of the handset while the application sends a telecommunication network query for high-level local mapping, localised data and wireless devices in the area. The high-level information consists of enough data for the handset-resident application to subsequently locate itself within the shopping centre. Along with this, an amount of Scalable Vector Graphics (SVG) data is transmitted which allows the mapping application to render a high-level view of the shopping centre area. Finally, enough meta-data in terms of general shop classifications and centre information is transmitted. Once the handset-resident application “sniffs” or detects the presence of a wireless beacon device for which it knows the location, it places the user on the map (i.e., within a radius of transmission of the detected beacon) and then, at the discretion of the user, uses that location to request more refined data from the network. The pattern of interaction between hand-set resident ‘proximity location detection’ application and other beacons, with the handset application determining its own proximate position and then using this to display the user on an appropriate map is repeated. Beacon location dependent meta-data such as shopping offers, specials, lists and catalogues are “pushed” to the user's attention. To ensure the user's privacy, the number of telephony network interactions should be small to ensure the exact location and shopping patterns cannot be determined by the network. This implies each request returns course-grained pieces of data.

In the Olympic Park scenario, a user in the park invokes the ‘proximity location detection’ application stored in the Bluetooth enabled cellular phone. In this case, fixed-location wireless devices within the buildings of the park act as beacons. The application proceeds to download a detailed park map, along with information about wireless access points, and daily information about events, opening times, booking details, and historical information about the Olympics that took place in such location. As the user moves from venue to venue more appropriate mapping and data is displayed.

It will be appreciated that the invention can be embodied with many modifications to the above described specific devices, subject to falling with the scope of the annexed claims. For example, numerous known techniques could be employed in initially determining the general geographic area of the user, notably GPS.

Furthermore, although it is important to the working of the invention that the mobile location indicating device passively detects beacons in order not to reveal the user's location within the general geographic area, a number of passive detection techniques could be employed. Short range wireless techniques are preferable in terms of ease of implementation. However, it is anticipated that visual detection techniques could be employed, in which case the mobile location indicating device would comprise visual image capturing means, such as a digital camera, and image recognition software for analysing the captured image to detect beacons within the captured image. The beacons could comprise some form of physical characteristic which provides the unique identifier and which could be recognised by the software.

What is claimed is:

1. A method of determining and indicating a proximate location of a user within a general geographical area, said method comprising the steps of:
a) determining the general geographical area in which the user is located;
b) requesting and downloading, onto a mobile location indicating device, data providing details of said general geographical area, said details comprising map data of said general geographical area, location data of beacons within said general geographical area and unique identifier(s) associated with each beacon;
c) the mobile location indicating device passively detecting one or more beacons within the proximity of the mobile location indicating device, and determining the unique identifier(s) of said one or more detected beacons;
d) the mobile location indicating device comparing the determined unique identifier(s) with the downloaded data, thereby determining respective location data of said one or more detected beacons; and
e) the mobile location indicating device communicating to the user said determined respective location data as the proximate location of the user within the general geographic area.

2. The method of claim 1, wherein said downloaded data further comprises information relevant to various locations within the general geographical area, the mobile location indicating device communicating to the user information which is relevant to the proximate location of the user.

3. The method according to claim 2, wherein said information is selected information based upon predetermined user preferences.

4. The method of according to claim 1, comprising the further step of:
a) requesting and downloading further data providing details specific to the proximate location of the user and the mobile location indication device communicating said further details to the user.

5. The method according to claim 1, wherein the proximate location of the user is communicated to the person in the form of a visual map display.

6. The method according to claim 1, wherein the mobile location indicating device comprises a mobile telephone handset.

7. The method according to claim 6, wherein the step of determining the general geographical area in which the user is located is provided by mobile positioning means in a telephony network.

8. The method according to claim 7, wherein said telephony network is a GSM network.

9. The method according to claim 1, wherein the step of determining the general geographical area in which the user is located is provided by GPS.

10. The method according to claim 1, wherein said beacons are passive transmitters.

11. The method according to claim 1, wherein said beacons are active transceivers.

12. The method according to claim 1, wherein the data is downloaded through a local wireless network.

13. The method according to claim 12, wherein said beacons form part of said local wireless network.

14. The method according to claim 1, wherein the step of passively detecting is carried out by using short range wireless technology.

15. The method according to claim 14, wherein said short range wireless technology is selected from the group comprising: Bluetooth, Wi-Fi and ultrawideband (UWB).

16. The method according to claim 1, wherein the step of detecting is carried out by capturing a visual image of the proximity of the mobile location indicating device and processing said captured image to recognise one or more beacons within the captured image.

17. A system for determining and indicating a proximate location of a user within a general geographical area, said system comprising:
a plurality of beacons located within the general geographical area, said beacons each having a unique identifier; and
a mobile location indicating device, said device comprising:
a geographical determinator for determining the general geographical area in which the mobile location indicating device is located;
a requestor for requesting and downloading data providing details of said general geographical area, said details comprising map data of said general geographical area, location data of said plurality of beacons and the unique identifiers associated with each of said plurality of beacons;
a beacon detector for passively detecting one or more beacons within the proximity of the mobile location indicating device;
an identification determinator for determining the unique identifier(s) of said one or more detected beacons;
a comparator for comparing the determined unique identifier(s) with the downloaded data and determining respective location data of said one or more detected beacons; and
a display for communicating to the user said determined respective location data as the proximate location of the user within the general geographic area.

18. The system according to claim 17, wherein said downloaded data further comprises information relevant to various locations within the general geographical area, said display further communicating to the user information which is relevant to the proximate location of the user.

19. The system according to claim 18, wherein said information is selected information based upon predetermined user preferences.

20. The system according to claims 17, wherein said requestor requests and downloads further data providing details specific to the proximate location of the user; and
said display communicates said further details to the user.

21. The system according to claim 17, wherein said display communicates to the user said determined respective location data as the proximate location of the user in the form of a visual map display.

22. The system according to claim 17, wherein the mobile location indicating device comprises a mobile telephone handset.

23. The system according to claim 22, wherein the geographical determinator uses information provided by mobile positioning functions in a telephony network.

24. The system according to claim 23, wherein the telephony network is a GSM network.

25. The system according to claim 17, wherein the geographical determinator uses GPS.

26. The system according to claim 17, wherein said plurality of beacons are passive transmitters.

27. The system according to claim 17, wherein said plurality of beacons are active transceivers.

28. The system according to claim 17, further comprising a local wireless network through which the data is downloaded.

29. The system according to claim 28, wherein said plurality of beacons form part of said local wireless network.

30. The system according to claim 17, wherein the beacon detector uses short range wireless technology.

31. The system according to claim 30, wherein said short range wireless technology is selected from the group comprising: Bluetooth, Wi-Fi and ultrawideband (UWB).

32. The system according to claim 17, wherein the beacon detector comprises:
an image capture device for capturing a visual image of the proximity of the mobile location indicating device; and
a processor for processing said captured image to recognise one or more beacons within the captured image.

33. A method of providing consumer information to a consumer within a general geographical area, wherein said consumer information pertains to goods and/or service providers within the proximate location of the consumer within the general geographical area, said method comprising the steps of:
determining the general geographical area in which the consumer is located;
requesting and downloading, onto a mobile device, data providing details of said general geographic area, said details comprising map data of said general geographical area, location of beacons within said general geographical area, unique identifier(s) associated with each beacon and consumer information relevant to the proximity of each beacon location;
the mobile device passively detecting one or more beacons within the proximity of the mobile device, and determining the unique identifier(s) of said one or more detected beacons;
the mobile device comparing the determined unique identifier(s) with the downloaded data, thereby determining respective location of said one or more detected beacons; and
the mobile device communicating consumer information relevant to the proximity of the determined respective location of said one or more detected beacons to the consumer.

34. The method according to claim 33, wherein said consumer information is selected information based upon predetermined user preferences.

35. The method according to claim 33, comprising the further step of:
requesting and downloading further data providing specific information to the determined respective location of said one or more detected beacons and the mobile device communicating said further data to the consumer.

36. The method according to claim 33, wherein the mobile device comprises a mobile handset.

37. The method according to claim 36, wherein the step of determining the general geographical area in which the consumer is located is provided by mobile positioning means in a telephony network.

38. The method according to claim 37, wherein said telephony network is a GSM network.

39. The method according to claim 33, wherein the step of determining the general geographical area in which the consumer is located is provided by GPS.

40. The method according to claim 33, wherein said beacons are passive transmitters.

41. The method according to claims 33, wherein said beacons are active transmitters.

42. The method according to claims 33, wherein the data is downloaded through a local wireless network.

43. The method according to claim 42, wherein said beacons form part of said local wireless network.

44. The method according to claim 33, wherein the step of passively detecting is carried out by using short range wireless technology.

45. The method according to claim 44, wherein said short range wireless technology is selected from the group comprising: Bluetooth, Wi-Fi and ultrawideband (UWB).

46. The method according to claim 33, wherein the step of detecting is carried out by capturing a visual image of the proximity of the mobile device and processing said captured image to recognise one or more beacons within the captured image.

47. A system for providing consumer information to a consumer within a general geographical area, wherein said consumer information pertains to goods and/or service providers within the proximate location of the consumer within the general geographical area, said system comprising:
a plurality of beacons located within the general geographical area, said beacons each having a unique identifier; and
a mobile device, said device comprising:
a geographical determinator for determining the general geographical area in which the mobile device is located;
a requestor for requesting and downloading data providing details of said general geographical area, said details comprising map data of said general geographical area, location of said plurality of beacons, the unique identifiers associated with each of said plurality of beacons and consumer information relevant to the proximity of each beacon location;
a beacon detector for passively detecting one or more beacons within the proximity of the device;
an identifier determinator for determining the unique identifier(s) of said one or more detected beacons;
a comparator for comparing the determined unique identifier(s) with the downloaded data and determining respective location of said one or more detected beacons; and
a display for communicating consumer information relevant to the proximity of the determined respective location of said one or more detected beacons to the consumer.

48. The system according to claim 47, wherein said consumer information is selected information based upon predetermined user preferences.

49. The system according to claim 47, wherein the requestor requests and downloads further data providing details specific to the proximate location of the user; and
said display communicates said further details to the consumer.

50. The system according to claim 47, wherein the mobile device comprises a mobile handset.

51. The system according to claim 50, wherein the geographical determinator uses information provided by mobile positioning functions in a telephony network.

52. The system according to claim 51, wherein said telephony network is a GSM network.

53. The system according to claim 47, wherein the geographical determinator uses GPS.

54. The system according to claim 47, wherein said beacons are passive transmitters.

55. The system according to claim 47, wherein said beacons are active transmitters.

56. The system according to claim 47, wherein the data is downloaded through a local wireless network.

57. The system according to claim 56, wherein said beacons form part of said local wireless network.

58. The system according to claim 47, wherein the beacon detector uses short range wireless technology.

59. The system according to claim 58, wherein said short range wireless technology is selected from the group comprising: Bluetooth, Wi-Fi and ultrawideband (UWB).

60. The system according to claim 47, wherein the beacon detector comprises:
an image capture device for capturing a visual image of the proximity of the mobile location indicating device; and
a processor for processing said captured image to recognise one or more beacons within the captured image.
